(19) United States
(12) Patent Application Publication
(10) Pub. No.: US 2002/0037414 A1
(43) Pub. Date: Mar. 28, 2002

(54) Low emissivity panel assembly

(76) Inventor: James A. Cunningham, Saratoga, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 09/905,680

(22) Filed: Oct. 1, 2001

Related U.S. Application Data
(60) Provisional application No. 60/218,916, filed on Jul. 18, 2000.

(51) Int. Cl. B32B 17/06; B32B 27/36

(52) U.S. Cl. 428/412; 428/38; 428/428; 428/426; 428/432; 428/433

(57) ABSTRACT

A panel assembly is for transmitting a desired portion of visible radiation while reflecting a large portion of incident infrared radiation. The panel assembly may include a transparent substrate, a barrier metal layer adjacent the transparent substrate, and a silver alloy layer adjacent the barrier layer. The barrier metal layer may preferably be metallurgically stable for the silver alloy. In addition, a silicon nitride layer may be provided adjacent the silver alloy layer on a side thereof opposite the barrier metal layer. In another embodiment, the silver alloy may include aluminum with a silicon nitride layer thereon and without the metal barrier layer.

### RELATED APPLICATION

This application is based upon provisional application Ser. No. 60/218,916, filed Jul. 18, 2000.

### FIELD OF THE INVENTION

This invention relates to coating systems for visibly transparent yet infrared reflecting glass panels useful for energy efficient, insulating glass windows and panels. The coatings have improved thermal and mechanical ruggedness and are stable upon long term storage before and after edge sealing.

### BACKGROUND OF THE INVENTION

A very large industry exists for the application of thin films to glass and other transparent substrates. Applications include: thin film electronic devices such as RC networks, liquid crystal displays and various transducers; mirrors and interference filters; and energy efficient glazing units for commercial buildings and homes. A large segment of this market is for double-glazed low emissivity solar control windows. These are used for the silver or bronze color mirror-look, or gray tinted glass covered high rise office towers that grace virtually all modern downtown areas in America

Various thin films are applied generally to soda-lime float glass panels to achieve high visible light transmission ranging from 50 to about 85% depending on market needs. The films may also substantially reflect incoming infrared (IR) solar radiation for energy efficiency in the summer, and then reflect the IR back into a heated room for increased energy efficiency in the winter. In order for the film stack to be highly IR reflecting in a useful wave length regime of 5 to 50 μm, a coating exhibiting a low emissivity in the range of about 0.2 to about 0.06 is desired.

A typical low emissivity film can reflect 85 to 94% of the thermal energy back into the room. A dielectric layer may also be used in the film stack to minimize visible reflectance. A hard passivation film is also needed as a final coating.

Premium double-pane solar control units are neutral in color, non-mirror in appearance, exhibit high visible light transmission, and very low emissivity. They resist weathering or other chemical attacks such as staining or pitting and they are resistant to abrasion. The coatings must also be economical to produce. The films must be sufficiently stable to resist optical property changes upon storage and edge sealing processes which may occur at elevated temperatures. The coatings generally reside on the inside of double glazed panels. The panels are often argon filled.

The various dielectric and metal thin film coatings have been applied by various methods such as chemical vapor deposition, electroplating and sputtering. Sputtering dominates the industry today. Companies producing low-E solar efficient glass by sputter coating include Airco, Cardinal IG, Ford, Guardian Industries, Interpane, Ply, The BOC Group, Pilkinton in England, and Leybold-Heraueus A.G. in Germany.

Coating systems typically range from four to as many as ten layers. But the heart of the system is usually a very thin pure-silver film which transmits the visible light and reflects IR energy. Other metals, such as copper may be used, if a certain non-neutral color or other property is desired.

The development of this industry, coating methodologies, optical factors and other information may be found, for example, in a book by Joseph S. Amstock entitled “Handbook of Glass in Construction”, Chapter 18, Low-Emissivity Coatings, pgs. 363-391, McGraw-Hill, 1997. U.S. Pat. No. 5,563,734 assigned to the BOG Group and U.S. Pat. No. 6,059,909 assigned to Guardian Industries, for example, contain details on film deposition methods, optical parameter evaluation and various industry-standard durability tests, such as humidity, salt fog, salt dot, UV, chemical immersion and abrasion tests.

Despite the growing success and growing market for these solar energy-efficient glass units, two problems or desirable improvements are mentioned as follows. A problem exists with the thin films of silver in that the silver film sometimes tends to agglomerate or roughen upon warehouse storage prior to the multiple panel assembly process. This changes the emissivity and may result in rejection of the coated glass. The problem occurs even though the glass is carefully wrapped in plastic or paper. The glass industry suspects some kind of subtle corrosion mechanism as the cause of this problem. Accordingly, a viable thin film stack is needed which has sufficient manufacturing latitude and robust character to be free of this problem.

Another desirable improvement for the coated glass is an increase in thermal stability of the coating stack to around 600° C. or substantially more. This could permit processes such as annealing, bending, tempering, hardening or heat sealing the edges after coating. In this latter case, the glass stock could be heated such that the panels slump together at the edges. Additional thermal stability could allow more robust peripheral edge sealing using soft glass, pyrocerams, or higher temperature cure elastomers. The ability to perform these various higher temperature processes would add flexibility and potential cost reduction factors to the manufacturing process. Unfortunately, it is difficult to apply a coating of uniform thickness to a curved section of glass. Panels made with higher thermal stability films might open new markets such as oven doors and windows for high temperature manufacturing processes.

Szezyrbowski, et al. in U.S. Pat. No. 5,201,926 discloses work on a film stack with a thermal stability designed to be high enough to survive a temperature of about 650° C. This might allow bending of a mineral glass substrate after the films were in place. A high visible light transmission, high thermal reflectivity film stack of a glass substrate/tin oxide/NiCr/Ag/NiCr/tin oxide was tested by heating in an oven in which peak temperatures of about 640° C. occur over a period of about 5 minutes. The patent discloses that this resulted in small changes in optical properties, and that the silver film could also be a silver alloy containing 50 weight-percent silver, but no specific alloying elements are suggested and no discussion is offered on how alloying the silver might effect the thermal stability or how to select workable alloying elements. The temperature of 640° C. is not high enough to allow bending of conventional soda-lime float window-glass with a softening point of about 730° C. There is no reason to believe that this system would be free of the low temperature agglomeration problem mentioned above.

With an objective toward improving the resistance of the silver film to attack by moisture and other chemicals, Szezyrbowski, et al. in U.S. Pat. No. 5,2791,722 discloses work on palladium or titanium-palladium “blockers” deposited against the silver in a film stack designed for low-E applications. Palladium and silver form a continuous series of solid solutions and would not serve as a diffusion barrier. The film stacks did well in moisture, salt spray and SO₂ accelerated life tests, but Szezyrbowski performed no elevated temperature tests.

Hart, in U.S. Pat. No. 4,462,883 discloses a film stack on glass of SnO₂/Ag/Cu/SnO₂. But Szezyrbowski, in patent '926, points out the of lack of thermal stability in Hart's system in the following statement, “[i]f such a sandwich, however, is exposed to temperatures above 150° C., the silver diffuses into the adjacent oxide and/or metal coating, and a great increase in the surface resistivity and a corresponding reduction of the transmissitivity of the sandwich is to be observed, i.e. two of the important properties of the sandwich are impaired.” This points out the importance of selecting workable metallurgically stable barriers, and incorporation of dielectrics which resist diffusion and penetration of silver and other metals in the film stack.

Nalopka and Huffer in U.S. Pat. No. 4,883,721 disclose a multilayer low emissivity thin film coating consisting of glass substrate/tin oxide, zinc oxide, titanium oxide, indium-tin oxide or bismuth oxide/Ag or a silver alloy of from 5% to 10% copper/Ti or stainless steel (type 316 is preferred)/tin oxide, zinc oxide, titanium oxide, indium-tin oxide or bismuth oxide. Focusing on optical properties, the patent does not discuss or evaluate the thermal stability of this system. Several of the elements suggested are not metallurgically stable in combination as defined herein. For example, copper and titanium form at least four compounds, copper and nickel found in stainless steel form a continuous series of solid solutions, copper and silicon found in alloy 316 form silicides, silver is about 4.5 wt. % soluble in titanium at 600° C. and the two elements form intermediate phase TiAg, and Ag diffuses rapidly through tin oxide at relatively low temperatures. No adhesion promoting film or diffusion barrier is provided between the bottom metal oxide layer and the silver.

Krisko in U.S. Pat. No. 6,060,178 discloses a heat-resistant film stack with high visible transmittance and low emissivity composed of glass/ZnO/Nb/Ag/Nb/ZnO/silicon nitride and other various combinations of this sequence. The film stack was said to allow tempering in air in the 700° C. range with changes in optical properties of about 10%. Although not mentioned in the patent, niobium is probably metallurgically stable, although this prediction is based on limited data regarding the binary phase diagram of Ag and Nb. Also not mentioned is the fact that the Nb—O bond energy is very high and the metal film would be expected to exhibit high adhesion to most oxide, glass or inorganic coating substrates. Niobium is an unproven yet possibly viable adhesion and diffusion barrier. The film stack would not be expected to free of the agglomeration problem mentioned above.

A typical prior art film stock for forming an energy efficient solar panel includes a transparent substrate or first layer such as polycarbonate or soda lime float glass. A second layer is a 300-400 Å thick antireflection dielectric layer such as sputter deposited TiO₂, SnO₂, Si₃N₄ or ZnO. The index of refraction is desirably about 2.0 to 2.5. A third layer is a very thin (5-15 Å thick) barrier or adhesion layer of NiCr, NiCrNx, or Ti. Sometimes this layer is omitted. A fourth layer is a low-E, 60-200 Å thick film of silver which transmits visible light. A fifth layer is a protective or sacrificial layer of 7-10 Å thickness of NiCr or NiCrNx or Ti. The Ti film may be oxidized to TiO₂ after forming. A sixth layer is a protective passivating layer of Si₃N₄, SnO₂ or TiO₂ which is 250 to 450 Å thick. All films are deposited by sputtering or reactive sputtering.

Various modification to this stack of films may be made such as two layers of silver, or different thickness ranges for various visual appearances, such as a mirrored look or a dark gray or bronze-like color.

One of the typical requirements for mainstream double-glazed solar efficient units is a low emissivity film, that is, the fourth layer as discussed above. The emissivity is the amount of radiation emitted from a substance at a given temperature relative to a black body which radiates all electromagnetic energy at any wavelength. The emissivity is one minus the reflectivity. Emissivities vary widely with different metals and over various wavelengths. FIG. 1, for example, shows emissivity values versus wavelength for polished samples of the metals Ag, Al, Cr, Cu, Ti and Zn. The data points have considerable scatter and should be assumed to be only approximate since the numbers are to some extent a function of surface finish, morphology and measurement method. For example, if the metal surface is rough, the emissivity rises.

The visible spectrum is from 0.4 to 0.7 μm. The IR spectrum of interest here is from about 5 to 50 μm. And for IR, the industry has established standard methods for measuring the emissivity in the range of 2.5 to 40 μm. In this regime, it may be seen that Ag, Al and Cu give desirably low values. Silver is especially low. Cr and Ti give higher values. Other metals exhibiting higher values of spectral normal emissivity at room temperatures, that is, values over 0.2 at 1 μm, for example, are antimony, bismuth, cadmium, cobalt, iridium, iron, magnesium, molybdenum, nickel, niobium, palladium, platinum, tantalum, tellurium, tin, tungsten, vanadium, and zinc.

Unfortunately, despite continuing developments in the area of material stacks for low-E panel assemblies, there still exists a need for such panel assemblies addressing the agglomeration difficulty and also leading to more efficient production techniques.

### SUMMARY OF THE INVENTION

In view of the foregoing background, it is an object of this invention to provide a panel assembly including a low-emissivity layer, such as using a base metal silver layer which will not agglomerate or roughen or otherwise degrade upon preassembly storage, such as at temperatures below about 45° C.

Another object is to provide such a panel assembly including a suitable low-emissivity stack of thin films such that temperatures of 600° C. or substantially more are possible during panel assembly into dual or multiple glass panel energy-efficient assemblies.

These and other objects, features and advantages in accordance with the present invention are provided by a panel assembly for transmitting a desired portion of visible radiation while reflecting a large portion of incident infrared radiation which in some embodiments includes a transparent substrate, a barrier metal layer adjacent the transparent substrate, and a silver alloy layer adjacent the barrier layer. The barrier metal layer may preferably be metallurgically stable for the silver alloy. In addition, a silicon nitride layer may be provided adjacent the silver alloy layer on a side thereof opposite the barrier metal layer. An antireflection layer may also be provided between the substrate and silver alloy layer.

The transparent substrate may comprise glass, or polycarbonate, for example. The silver alloy may comprise silver and copper. For example, the silver alloy may comprise 0.5 to 20 atomic percent copper.

The silver alloy may alternately comprise silver and aluminum. For example, the silver alloy may comprise 5 to 20 atomic percent aluminum. In these embodiments, the barrier metal layer may not be needed.

The barrier metal layer may comprise at least 50 atomic percent chromium. The barrier metal layer may comprise a nitride compound. In other embodiments, the barrier metal layer may comprise at least one of boron, carbon, vanadium, tungsten, tantalum, rhenium, rhodium, iridium, molybdenum, and ruthenium. In yet other embodiments, the barrier metal layer may comprise an amorphous TaSiN film or an amorphous CrSiN film.

The silver alloy film may have a thickness in a range of about 60 to 200 Å, for example. The silver alloy layer may comprise an element having a relatively low solubility in silver and which forms one or more intermetallic compounds with silver. The silver alloy layer may comprise at least one of barium, calcium, gadolinium, samarium, strontium, tellurium and ytterbium.

The substrate may define a first panel and may be the only panel in the panel assembly. In other embodiments, the assembly may further comprise a second panel connected to the first panel at peripheral edges thereof. In other words, the panel assembly may be a dual pane window or door panel. Of course, panel assemblies including three or more panels are also contemplated by the invention.

### BRIEF DESCRIPTION OF THE DRAWINGS

FIG. 1 is a plot of emissivity versus the wavelength of light in microns for seven metals as in the prior art.

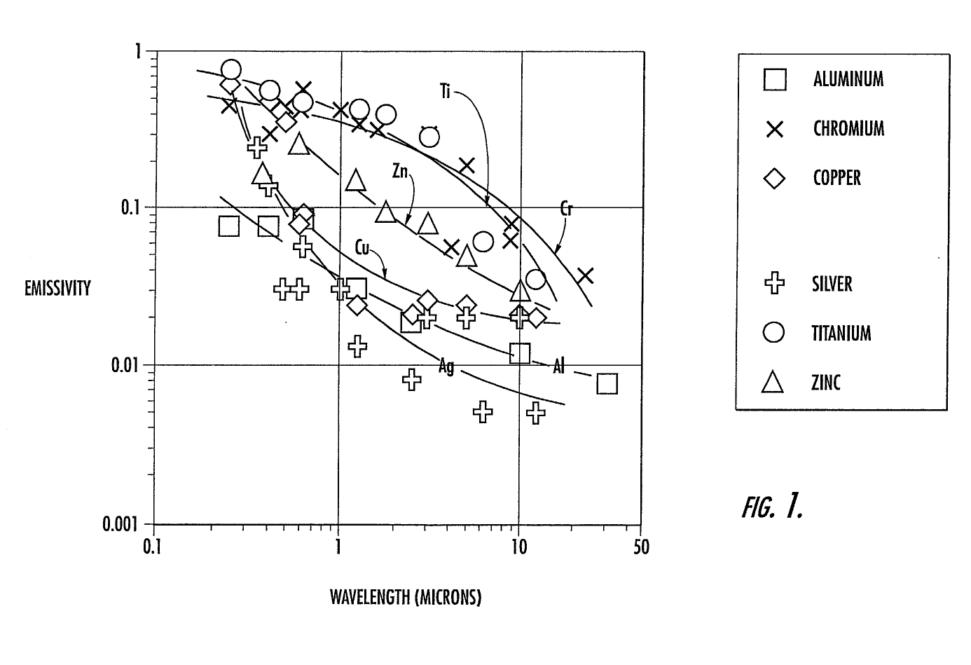

FIG. 2 is a front elevational view of a building wall portion including low-E panel assemblies in accordance with the present invention.

FIG. 3 is a schematic cross-sectional view of a first embodiment of a low-E panel assembly in accordance with the present invention.

FIG. 4 is a schematic cross-sectional view of a second embodiment of a low-E panel assembly in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternate embodiments.

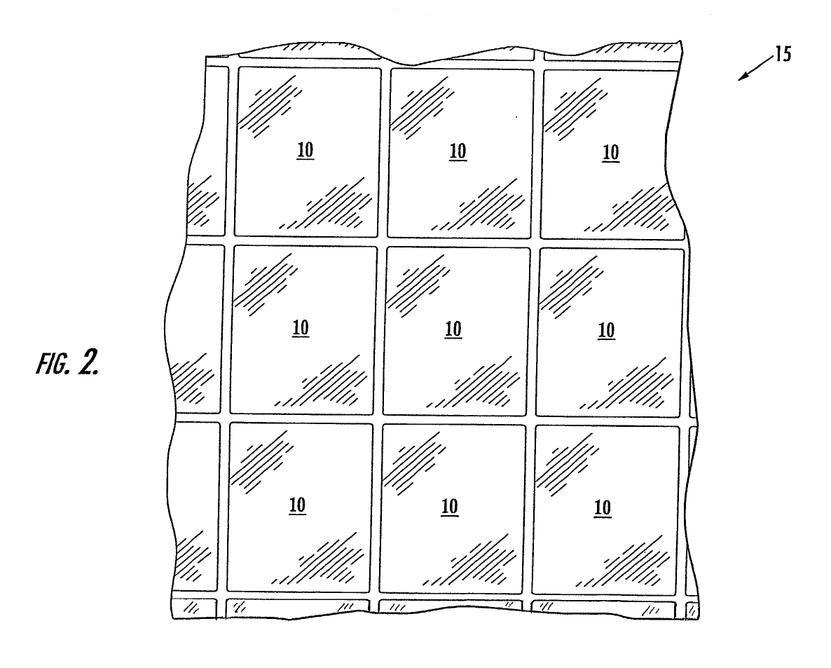

The present invention is based upon an application of thin films in integrated circuits together with a basic understanding of metallurgical principles to solve a problem in another industry: degradation by agglomeration of pure silver films used in low-E solar panels. As shown in FIG. 2, the invention is directed to a panel assembly 10 that may be arranged on the outside of a building 15 to form a wall portion thereof. In particular, as will be explained in greater detail below, the panel assembly 10 is for transmitting a desired portion of visible radiation while reflecting a large portion of incident infrared radiation. In addition, the panel assembly 10 overcomes the agglomeration problem of conventional assemblies, and may also permit additional manufacturing steps to be performed at relatively higher temperatures.

Low-E energy-efficient glass window units or panels generally use a very thin layer of pure silver sandwiched between other films. The silver film is so thin that visible light is transmitted through it, yet IR radiation is reflected. The silver film is deposited by sputtering as are the other layers. These films can contain sufficient stored energy in the form of stress, large areas of grain boundaries with high concentrations of vacancies, lattice defects and chemical free energy such that recrystallization or stress migration may occur spontaneously below normal recrystallization temperatures. When this occurs, the silver layer roughens and the optical properties, primarily emissivity, degrade thereby spoiling the panel.

One aspect of this invention is directed to a replacement of the pure silver layer with suitable alloys exhibiting much higher recrystallization temperatures. This will prevent changes in film properties upon long term storage near room temperature and above. In addition, combining this embodiment with suitable metallurgically stable barriers or adhesion layers, gives rise to a thin film stack capable of thermal processing in excess of 600° C.

In general, if another metal is added to a pure base metal forming an alloy the hardness and tensile strength, relative to the pure metal, will increase substantially. For example, commercial Al alloys containing small amounts of Cu, Mn, Mg and sometimes Si exhibit an increase in tensile strength and hardness by about a factor of five times. Copper containing 8% Al is about double the hardness of pure Cu. Sterling silver, containing about 7.5% Cu, has a tensile strength about twice that of pure silver. Exceptions to this rule are two metals which are mutually soluble in all proportions and form no compounds. Thus, adding platinum or gold to palladium has little effect on hardness.

Alloys, in general, also exhibit much higher recrystallization or annealing temperatures. This is because the rate of self diffusion of the base metal is suppressed by addition of a dopant metal. Thus, by addition of carefully selected dopant metals to a base metal of silver, a low value of emissivity may be preserved while significantly increasing the metal's resistance to recrystallization or agglomeration or atomic rearrangement from reactions to high levels of stress and other factors.

In addition, sputtered alloy films, as opposed to pure metal films, tend to have smaller grain size upon deposition. This adds to their specular character, a property tending to minimize the emissivity.

The following Table 1 lists approximate recrystallization temperatures for several metals and alloys. The temperatures are for complete recrystallization of a highly cold-worked material in one hour, in other words, the temperature to return the metal to a strain-free condition.

TABLE 1

| Material | Recrystallization Temp ° C. |
|---|---|
| Copper (99.999%) | 121 |
| Copper, 5% Zinc | 315 |
| Copper, 5% Aluminum | 287 |
| Aluminum (99.999%) | 79 |
| Aluminum (90.0%) | 288 |
| Aluminum alloys, commercial | 315 |

Thus, it is seen that adding impurities and alloying elements to a pure metal significantly lowers its rate of self diffusion at a given temperature. Normally, recrystallization is a process involving the nucleation of strain-free crystals and of grain size growth. Large grains have lower free energy than small ones since the amount of grain boundary area is reduced. The new crystals often appear at the more drastically deformed portions of the grain of a worked-hardened metal.

In thin films, the release of strain by recrystallization or annealing is often accompanied by roughening, that is growth of hillocks and voids, or more generally, agglomeration. The impurity atoms in alloys tend to slow the solid state diffusion process involved by reducing grain boundary diffusion rates, pinning of slip planes, and by other strain-related diffusion interference mechanisms. Reduction of grain boundary diffusion rates is sometimes referred to as grain boundary stuffing and may be particularly effective if intermetallic compounds are deposited there.

The introduction of insoluble impurities or compounds increases nucleation processes and the precipitated materials generally act as barriers to the growth of grains and the reduction of stress. But full annealing may restore a material to a strain-free lattice structure with more easily movable slip planes and is essentially a softening process.

Some alloys may be strengthened and hardened by a heat treatment process called age hardening. These are alloys where the slope of the solubility line in the alpha phase is greater at higher temperatures. The hardening is accomplished by first heating to a temperature where the dopant metal is completely dissolved. The alloy is then cooled quickly to room temperature such that the dopant is supersaturated. The excess solute is then precipitated in an aging process at modestly elevated temperatures or sometimes at room temperature. An alloy of aluminum and copper may be age hardened, for example, at room temperature. As distortion of the lattice increases, hardness and tensile strength rise.

Another alloy which may be age hardened is an alloy of copper and beryllium. The maximum solubility of copper in silver is about 14.1 at. % (at 779° C.) and the slope of the solvus line indicates the possibility of age-hardening certain alloys. Sterling silver (7.5 wt. % Cu) and coin silver (10 wt. % Cu) are age-hardenable alloys.

More generally, when a second element is dissolved into a base metal, the process may be referred to as solution hardening.

For the bulk metals Ag, Cu, Al and Au, from the point of view of traditional metallurgical considerations, a significant amount of recrystallization is not expected to occur at room temperature in a time frame of even several weeks. This can be seen from a calculation of the diffusion length \sqrt{Dt} where D is the diffusion constant D and t is the time. Using lattice diffusion constants at 100° F., for example, and a time of one month, the diffusion lengths are less than one atomic diameter. But for thin films, other factors come into play. Energy may be stored at grain boundaries and in the form of stress. Diffusion rates at surfaces and at grain boundaries may occur at much higher rates and at much lower activation energies. Also, since Cu, Ag and Au, for example, do not form strong oxygen bonds or passivating oxide surface layers, these elements may exhibit very high surface diffusion rates. This would effect thin films to a much greater extent than for bulk forms.

High rates of stress relief, creep, film roughening, void formation and grain growth have been occasionally noticed in the electronics industry for thin films of Cu and Al. Some of these observations are noted below.

During the 1970's and early 1980's integrated circuits were metallized with an aluminum alloy containing about 1% silicon. This alloy formed the interconnects or wiring. Silicon is almost insoluble in aluminum (about 0.05 wt. % at 250° C.) and most of it precipitates out as large crystals during the various heat cycles in the manufacturing process. Several papers appeared in the mid 1980's regarding the appearance of electrical opens in the A1+Si films upon storage or temperature cycling to modest upper temperature values around 75 to 90° C. The open interconnect lines were a result of voids and cracks produced by a stress relief mechanism. The failure rate was increased by sputtering the alloy in nitrogen and passivating the films with silicon nitride at high levels of compressive stress.

This suggests that a major factor in atomic movement in thin films is the magnitude of the stored free energy in the film and in any overcoating layers. By addition of about 2 wt. % copper, this failure mode was eliminated. Aluminum and copper form several ordered phases; these, probably the theta phase, tend to precipitate at grain boundaries thus reducing grain boundary diffusion rates. Aluminum diffusion in thin films generally occurs mainly at the grain boundaries.

Technical papers on this phenomenon are, for example, Jon Klema, et al., “Reliability Implications of Nitrogen Contamination During Deposition of Sputtered Aluminum/Silicon Metal Films”, IEEE Rel. Physics Sym. 1984, pg. 1 and T. Turner and K. Wendel, “The Influence of Stress on Aluminum Conductor Life”, IEEE Rel. Physics Sym. 1985, pg. 142.

More recently, with the advent of the use of pure copper for metal interconnects in integrated circuits, it has been noticed in the case of electroplated copper about one micron in thickness, that the films can exhibit a remarkable order of magnitude increase in grain size and a decrease in compressive stress to near zero compressive stress values. These changes may occur at room temperature over a period of several hours. The effect is also accompanied by an increase in electrical conductivity; this would be an expected result following a grain boundary area decrease. Additional discussion and references on this peculiar phenomenon may be found in a paper by Panos C. Andricanos, “Copper On-Chip Interconnections, A Breakthrough in Electrodeposition to Make Better Chips”, The Electrochemical Society Interface, Spring 1999, pg. 32.

A viable multi-layer thin film stack must have both good adhesion to the transparent substrate and between layers. This is because the layers must survive scratch-free and peel-free through varying periods stored between paper or plastic sheets, handling in the multi-panel assembly process, and thermal cycling in the final service condition.

The adhesion of sputtered or evaporated metal films to glass or other oxidized materials is strongly related to the metal-oxygen bond strength which decreases, for example, as Ti>Al>Cr>Ni>Cu≅Ag>Au. In the electronics industry, the list of time proven metal glue layers or strongly adhering peel-free deposited thin-film metals is quite short, including only Ti, Al and Cr. Other elements having strong oxygen bonds may be sited such as Ta, W and Mo, but these films often are in high stress and are quite brittle—properties leading to possible delamination problems. Thus, these metals are are not normally applied directly to a substrate, but over glue layers.

Many other metals are routinely proposed or listed in the technical or patent literature as exhibiting satisfactory adhesion in thin film form. However, in a manufacturing environment, where wide process latitude is necessary, only the venerable metals listed above have proven practicable and reproducible over time. The adhesion of copper or silver films is typically very low, and glue or adhesion promoters are almost invariably employed for their use. Metal-to-metal thin film layers are generally well bonded. Sputtered coatings are generally more strongly adhered than evaporated ones.

But an alloy of base metal copper or silver containing a substantial percentage of aluminum, for example, would have good adhesion without use of an adhesion underlayer. For example, in an alloy of silver containing 20 at. % Al, 1 in 5 atoms in contact with the substrate would be firmly bound Al. Such an alloy film would exhibit greater adhesion than pure silver. More generally copper or silver could be generously alloyed with any of the three well known glue layers listed above and the adhesion to a dielectric substrate would be improved.

The electronics industry has critical needs for both metal and dielectric diffusion barriers, and a great many materials have been evaluated. For example, it is known that the diffusion rate of copper, nickel, gold and alkali metals, for example, and various other elements through SiO₂ and various glasses is very high, but virtually zero in silicon nitride. The various dielectrics mentioned in much of the patent literature for low emissivity coatings such as oxides of tin, titanium, zinc, bismuth are not used in the integrated circuit industry even though they may have desirable electrical properties in certain cases. The premier passivation, diffusion barrier, and higher dielectric constant insulating film is silicon nitride.

In terms of the manufacturing of integrated circuits, a practicable metal diffusion barrier with full metallurgical stability does not exist for aluminum. Beryllium would probably work but may be too toxic for actual use. Nevertheless, two materials have seen wide use: a mixture of Ti and W usually deposited containing some nitrogen, and the compound TiN. These barriers are termed sacrificial, in that at elevated temperature the penetration rates and compound formation rates are slow enough such that the devices can successfully survive short periods of temperatures near 450° C. as required in the manufacturing process. The system will survive long term storage at around 150° C. with no obvious effects on the thin film morphology. A typical aluminum alloy used on semiconductor devices used against these barriers is Al+1% Cu+1% Si.

It may be seen from handbook emissivity values of metals and alloys that an alloy emissivity is close to a weighted average value. For example, the following emissivity values from Tables 2 and 3 make this conclusion clear.

TABLE 2
Emissivity at 0.65 μm

| | |
|---|---|
| Pt | 0.3 |
| Rh | 0.24 |
| 90Pt—10Rh | 0.27 |

(The weighted average of the alloy calculated from the elements is 0.29)

TABLE 3
Emissivity of total radiation

| | |
|---|---|
| Cu, 200° C. | 0.02 |
| Zn, 200-300° C. | 0.04-0.05 |
| brass, 200° C. | 0.03 |

(Brass is Cu + 15. to 36 wt. % Zn)

In order for the stack of films used in the subject panels to exhibit a thermal stability above 600° C., the glue layers should desirably not interdiffuse with the Ag or Ag alloy, nor should the Ag or Ag alloy react or interdiffuse with the dielectric layers and upon possible penetration of the barrier or glue layers on opposite sides of the low-E or silver layer. Also, the silver alloy should not recrystallize significantly nor creep or otherwise substantially move in reaction to stress.

Penetration or reaction with the thin barrier or glue layers with the silver or silver alloy contacting them may be minimized by assuring that they are metallurgically stable with the silver or silver alloy. This requires very low mutual solubility in the alpha phase of the metals, and the existence of substantially no intermetallic compounds. This property of viable barrier metals has been discussed in copending patent applications to the present inventor including U.S. patent application Ser. No. 09/045,610 filed Mar. 20, 1998; Ser. No. 09/148,096 filed Sep. 4, 1998; Ser. No. 09/271,179 filed Mar. 17, 1999; No. 60/153,400 filed Sep. 10, 1999; and No. 60/159,068 filed Oct. 12, 1999 the entire disclosures of which are incorporated herein by reference.

The following Table 4 lists low-E base metals of interest, together with metallurgically stable barrier metals.

TABLE 4

| Base Metal | Barrier Metal |
|---|---|
| Ag | B, C, Be, Co, Fe, Ir, Si, W, Ta, |
| | Cr, Mo, Ni, Re, Rh, Ru, V, Re, and |
| | probably Nb |
| Cu | B, C, Cr, Mo, T1, Ta, W, Ru, Re, |
| | Rh, V, and probably Nb and Ir |
| Al | Be |

Thus, the widely used Cr+Ni (nichrome) alloy for the barrier or glue layers is a suitable barrier for Ag, but not for a Ag+Cu alloy. Cu and Ni form a continuous series of solid solutions, properties which maximize their propensity to interdiffuse. Suitable barriers for Ag+Cu alloys are metals or combinations of metals which are metallurgically stable for both metals in the alloy. An example is Cr, or CrNx which would tend to have reduced grain boundary diffusion rates via a stuffing mechanism, as is known in the art. Cr metal also exhibits good adhesion.

Ignoring the need for reproducible adhesion for now, other candidates include B, C, V, W, Ir, Ta, Re, Rh, or Ru or combinations of these metals. Barrier metals for Al are very limited, and Be is probably too toxic to be considered. The electronics industry makes use of sacrificial barriers for Al such as Ti:W alloy or the compound TiN. But these may not be robust thermal barriers against Ag diffusion. Considering diffusion lengths 4Dt for about 30 min., Ag+Al films against the Ag barriers mentioned above would probably be stable up to about 300° C.

Another selection criterion for dopant atoms that will stabilize and harden silver films is based on adding metals which will reduce grain boundary diffusion rates by way of compound precipitation. Metals which exhibit very low solubility in silver and also form one or more stoichiornetric intermetallic compounds will, upon heat treatment, tend to diffuse from mostly interstitial sites within grains, to grain boundaries where they precipitate as compounds. This tends to stuff the grain boundaries, reducing the vacancy concentration there, thereby reducing grain boundary diffusion rates. Such alloys in the form of thin films would tend to be more thermally stable in terms of maintaining the as-deposited morphology.

Metal dopants which have this metallurgical property with silver include barium, calcium, gadolinium, samarium, strontium, tellurium, and ytterbium. Since these metals are not expected to have low emissivity values, like the alloying elements listed above, they should serve for this application if added in low concentrations of about 5% or less.

Other viable alloys may be formed with base metals using various other dopants as long as the concentration of the dopant is not so high that the resulting alloy emissivity value becomes prohibitively high and the energy efficiency of the film stack becomes non-competitive in the marketplace.

Since Ag and silicon do not form silicides, viable barrier films for very high temperature stable stacks may be prepared using amorphous films such as TaSiN or CrSiN. These films are known in the art to exhibit very high performance as diffusion barriers in the 700 to 800° C. range.

One exemplary alloy which may be substituted for pure silver in the low-E coating stock discussed herein is silver plus about 1 to 10 at. % Cu. Such an alloy, using these two low-emissivity metals would remain below about 0.08 to 0.1 even in the visible range using as much as 10% Cu. The liquidus regime of such an alloy would range from about 840 to about 950° C. depending on the Cu concentration.

Another exemplary alloy could be made of silver and about 1 to 10 at. % Al. At the 2.5 μm wavelength, such an alloy should exhibit an emissivity of less than 0.03 in the IR range above about 2 μm. The liquidus of such Ag+Al alloys would lie above 850° C. Other viable alloys, with lower performance optical properties, could be prepared from comparable or lower concentrations of other dopant metals in silver. Viable alloys may also be prepared from base metal copper and suitable metal dopants in low concentration. These might be used for bronze colored glass panels, for example.

Alloys of silver may be deposited by sputtering from targets of the alloy, for example, although other deposition techniques may also be used.

The above teachings may be applied for creation of viable thermally stable film stacks using copper or gold as the low-E the base metal. For less aggressive temperature stability needs, low-E films stacks may be prepared with Al based metallurgy.

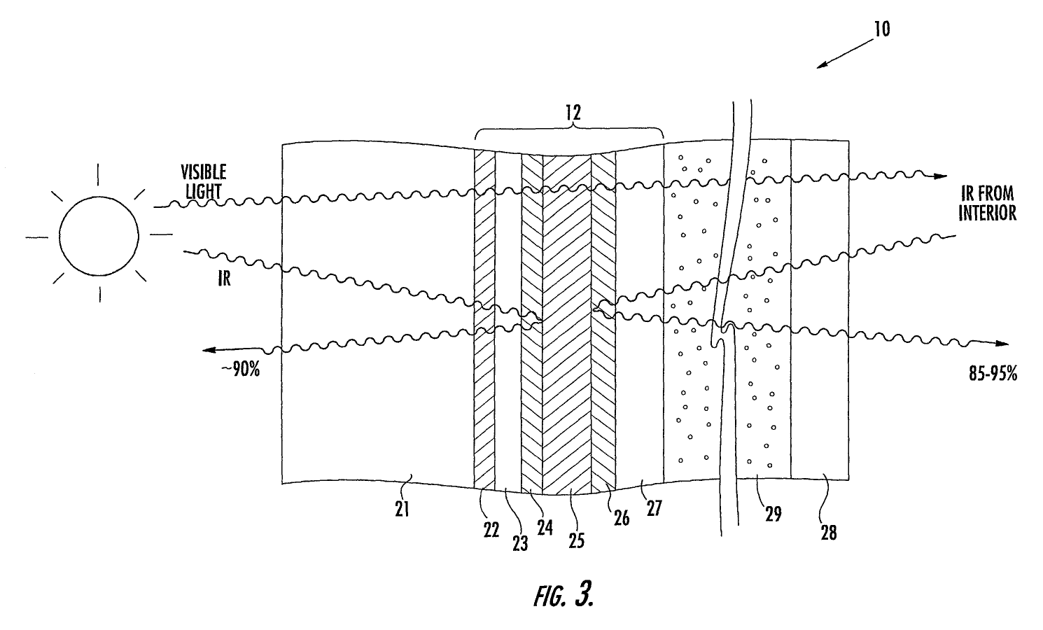

An embodiment of a high temperature stable film stack 12 on a glass substrate 21 with low-E (En) values ≦0.08, in the 2.5 to 40 μm wavelength range, and visible transmission values of about 76 to about 83% with a neutral color and a non-mirror look is explained with reference to the panel assembly 10 shown in FIG. 3. The stack 12 may be prepared by sequential sputtering using well known magnetron sputtering technology using the following exemplary films and film thicknesses: a layer 22 of TiO₂ (200-250 Å)/a layer 23 of Si₃N₄ (40-60 Å)/a layer 24 of CrNx (7-30 Å)/a layer 25 of Ag+5 at. % Cu+Nx (150-180 Å)/a layer 26 of CrNx (7-15 Å)/another layer 27 of Si₃N₄ (400-500 Å). A second glass substrate 28 may be connected at its peripheral edges to the first panel defined by the substrate 21 and its film stack 12 as will be readily appreciated by those skilled in the art. In addition, a gas layer 29, such as of Argon, may be provided between the two panels. Of course, more than two panels may be used in a multi-panel configuration, and only a single panel may also be used in other embodiments.

The titanium oxide may be sputtered from Ti targets in 49% O₂ and argon with a target refractive index of 2.5-2.6 at 550 nm. The nitride may be sputtered from silicon targets in about 85% nitrogen and argon. The chromium may be sputtered from Cr targets in 10 to 40% nitrogen and argon. The silver alloy may be sputtered from alloy targets in 10 to 40% argon. After film formation, the glass panels may be heated in air at temperatures in the range of about 700° C. to about 750° C., or substantially less, for bending or tempering operations or other high temperature treatment needs.

The high temperature stability of the film stack or stacks described above may be assured or improved, prior to high temperature exposure in air, by annealing in nitrogen at a temperature of approximately 400° C. in order to densify the films and insure completion of the nitrogenation process.

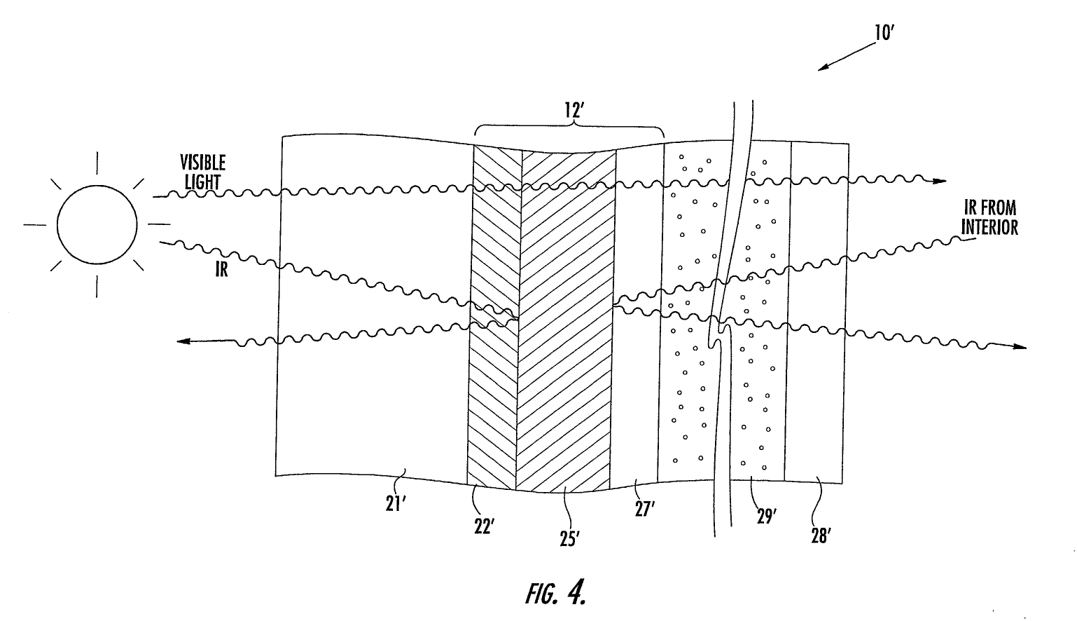

A lower cost glass panel 10′ may be similarly prepared and having a slightly different film stack 12′ as shown in FIG. 4. The film stack 12′ includes a layer 22′ of TiO₂/a layer 25′ of Ag+about 20 at. % Al+Nx/a layer 27′ of Si₃N₄. This stack 12′ would provide for lower temperature stability needs up to about 300° C., and emissivity targets of about 0.1, and approximate transmission values of ≦82%. Film thicknesses may vary depending on market needs. A gas layer 29′ and second glass or polycarbonate substrate 28′ may also be provided.

Both film stacks are free from lower temperature Ag agglomeration or other morphology effects upon long time storage, and both systems offer high film adhesion and improved abrasion resistance and hardness. Resistance to chemical and environmental attack is comparable or better than viable prior art films.

Many modifications and other embodiments of the invention will come to the mind of one skilled in the art having the benefit of the teachings presented in the foregoing descriptions and the associated drawings. Accordingly, it is understood that the invention is not to be limited to the illustrated embodiments disclosed, and that the modifications and embodiments are intended to be included within the spirit and scope of the appended claims.

That which is claimed is:

1. A panel assembly for transmitting a desired portion of visible radiation while reflecting a large portion of incident infrared radiation and comprising:
a transparent substrate;
a barrier metal layer adjacent said transparent substrate; and
a silver alloy layer adjacent said barrier layer;
said barrier metal layer being metallurgically stable for said silver alloy.

2. A panel assembly according to claim 1 further comprising a silicon nitride layer adjacent said silver alloy layer on a side thereof opposite said barrier metal layer.

3. A panel assembly according to claim 1 further comprising an antireflection layer between said transparent substrate and said barrier metal layer.

4. A panel assembly according to claim 1 wherein said transparent substrate comprises glass.

5. A panel assembly according to claim 1 wherein said transparent substrate comprises polycarbonate.

6. A panel assembly according to claim 1 wherein said silver alloy comprises silver and copper.

7. A panel assembly according to claim 6 wherein said silver alloy comprises 0.5 to 20 atomic percent copper.

8. A panel assembly according to claim 1 wherein said silver alloy comprises silver and aluminum.

9. A panel assembly according to claim 8 wherein said silver alloy comprises 5 to 20 atomic percent aluminum.

10. A panel assembly according to claim 1 wherein said barrier metal layer comprises at least 50 atomic percent chromium.

11. A panel assembly according to claim 1 wherein said barrier metal layer comprises a nitride compound.

12. A panel assembly according to claim 1 wherein said barrier metal layer comprises at least one of boron, carbon, vanadium, tungsten, tantalum, rhenium, rhodium, iridium, molybdenum, and ruthenium.

13. A panel assembly according to claim 1 wherein said barrier metal layer comprises an amorphous TaSiN film.

14. A panel assembly according to claim 1 wherein said barrier metal layer comprises an amorphous CrSiN film.

15. A panel assembly according to claim 1 wherein said silver alloy layer h as a thickness in a range of about 60 to 200 Å.

16. A panel assembly according to claim 1 wherein said silver alloy layer comprises an element having a relatively low solubility in silver and which forms one or more intermetallic compounds with silver.

17. A panel assembly according to claim 1 wherein said silver alloy layer comprises at least one of barium, calcium, gadolinium, samarium, strontium, tellurium and ytterbium.

18. A panel assembly according to claim 1 wherein said first substrate defines a first panel; and further comprising a second panel connected to said first panel at peripheral edges thereof.

19. A panel assembly for transmitting a desired portion of visible radiation while reflecting a large portion of incident infrared radiation and comprising:
a transparent substrate;
a silver alloy layer adjacent said substrate and comprising silver and aluminum; and
a silicon nitride layer adjacent said silver alloy layer on a side thereof opposite said substrate.

20. A panel assembly according to claim 19 further comprising an antireflection layer between said transparent substrate and said silver alloy layer.

21. A panel assembly according to claim 19 wherein said transparent substrate comprises glass.

22. A panel assembly according to claim 19 wherein said transparent substrate comprises polycarbonate.

23. A panel assembly according to claim 19 wherein said silver alloy comprises 5 to 20 atomic percent aluminum.

24. A panel assembly according to claim 19 wherein said silver alloy film has a thickness in a range of about 60 to 200 Å.

25. A panel assembly according to claim 19 wherein said first substrate defines a first panel; and further comprising a second panel connected to said first panel at peripheral edges thereof.
